(19) United States
(12) Patent Application Publication
(10) Pub. No.: US 2009/0277076 A1
(43) Pub. Date: Nov. 12, 2009

(54) Device For Elimination Of Mosquitoes And Flying Pests

(76) Inventor: Thomas William Boston, Dallas, TX (US)

Correspondence Address: CARSTENS & CAHOON, LLP, P O BOX 802334, DALLAS, TX, 75380, US

(21) Appl. No.: 12/118,504

(22) Filed: May 9, 2008

(51) Int. Cl. A01M 99/00

(52) U.S. Cl. 43/132.1

(57) ABSTRACT

The present invention provides a device for eliminating mosquitoes and other harmful flying insects by eradicating the eggs and larvae laid or deposited in the device. The device is an electrically operated, self-contained, compact device that eliminates harmful flying insects and/or mosquitoes by attracting the insects to lay their eggs in a body of liquid within the device. This is accomplished with the use of attractants in the device, in the liquid, on the device, or around the device. The body of liquid acts as a breeding ground which is then periodically drained by a valve onto a screen or mesh of sufficient size to filter and separate eggs and larvae from the liquid. The eggs and larvae are then crushed, smashed, or otherwise destroyed by mechanical means. The liquid flows through a filter media, making it ready to be recycled from a reserve tank for reuse in refilling the body of liquid in the device.

### TECHNICAL FIELD

The invention is a device for eliminating mosquitoes and other harmful flying insects by eradicating the eggs and larvae deposited in the device.

### BACKGROUND OF THE INVENTION

Mosquitoes and several other species of flying insects act as vectors for diseases that are dangerous to animals and humans. Over one million people die each year from mosquito-borne diseases. According to the World Health Organization, malaria alone affects 400 million people each year. About 1,200 Americans are infected with malaria each year, most while traveling abroad. Malaria is a tropical disease and is most severe in Africa where it kills two million people each year either directly or in combination with acute respiratory infections. In approximately the past decade, dengue hemorrhagic fever emerged in Latin America and has reached as far north as the Texas border. Mosquitoes have also contributed to the spread of West Nile Virus and other encephalitis diseases over the United States in just three years.

Various methods and devices have been proposed for killing or reducing the population of mosquitoes and other flying pests or at least to prevent them from bothering the human population with their presence. Each of these methods and devices has its own unique set of problems or limitations.

One such method is to trap the mosquitoes or mosquito larvae in a device that does not permit the mosquitoes from exiting the device, thereby causing the mosquitoes to die within the device. One obvious limitation with this method is that not all of the mosquitoes will be trapped, and those that are not trapped, will continue to breed and replenish the mosquito population.

Another prior art method comprises adding an organic chemical such as alcohol or oil to bodies of water in which the mosquitoes breed in order to kill the larvae. The organic chemical floats on the top of the water and prevents the larvae from reaching the air, thereby causing the larvae to suffocate. This method is limited in use because it is only effective for use in still bodies of water, not flowing water which disrupts the oil layer allowing the mosquito larvae to escape without suffocating. Moreover, the addition of alcohol or oil to a body of water fouls the water and pollutes it, often endangering desirable fish, birds, insect and plant life.

Other methods involve introducing a chemical scent that either repels the mosquitoes away from the area where humans are present, or alternately, masks the scent of the humans to the mosquitoes so that they can not locate the humans to bite them. However, these methods do nothing to reduce the mosquito population and have a limited effective range. If a human ventures beyond the limited range of the chemical scent, the mosquitoes will be able to locate the human and bite him. This is the same principal used by citronella candles as well as products that are sprayed on the human's body. Unfortunately, these sprays are known carcinogens and can present a particularly acute health hazard for young children.

Another well known method involves attracting and then electrocuting the adult mosquitoes, or alternately using an insecticide to kill them. Electrocution of mosquitoes is noisy, and does not kill a significant percentage of the mosquito population, and those mosquitoes that are not killed will continue to breed and replenish the mosquito population available.

An even older method is to simply spray insecticides. However, these insecticides can be harmful to humans, animals and the environment, and recently have been found to be ineffective in killing mosquitoes because the concentrations allowed for by the government for human health reasons has allowed the mosquito population to build a resistance to the insecticides. Furthermore, insecticides are not selective and can kill beneficial insects that help in pollination of crops. Finally, insecticides can reach water supplies and contaminate the drinking water.

Therefore, it would be desirable to have a device that not only controls the adult population of mosquitoes and other flying pests but also reduces their reproduction without harm to the environment or humans and other animals and beneficial insects.

### SUMMARY OF THE INVENTION

The present invention provides a device for eliminating mosquitoes and other harmful flying insects by eradicating the eggs and larvae laid or deposited in the device. The device is an electrically operated, self-contained, compact device that eliminates harmful flying insects and/or mosquitoes by attracting the insects to lay their eggs in a body of liquid within the device. This is accomplished with the use of attractants in the device, in the liquid, on the device, or around the device. The body of liquid acts as a breeding ground which is then periodically drained by a valve onto a screen or mesh of sufficient size to filter and separate eggs and larvae from the liquid. The eggs and larvae are then crushed, smashed, or otherwise destroyed by mechanical means. The liquid flows through a filter media, making it ready to be recycled from a reserve tank for reuse in refilling the body of liquid in the device.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1A is a right-facing cutaway view of the present invention;

FIG. 1B is a left-facing cutaway view of the present invention; and

FIG. 2 is a detailed cutaway view of the grinding device in accordance with the present invention.

### DETAILED DESCRIPTION OF THE DRAWINGS

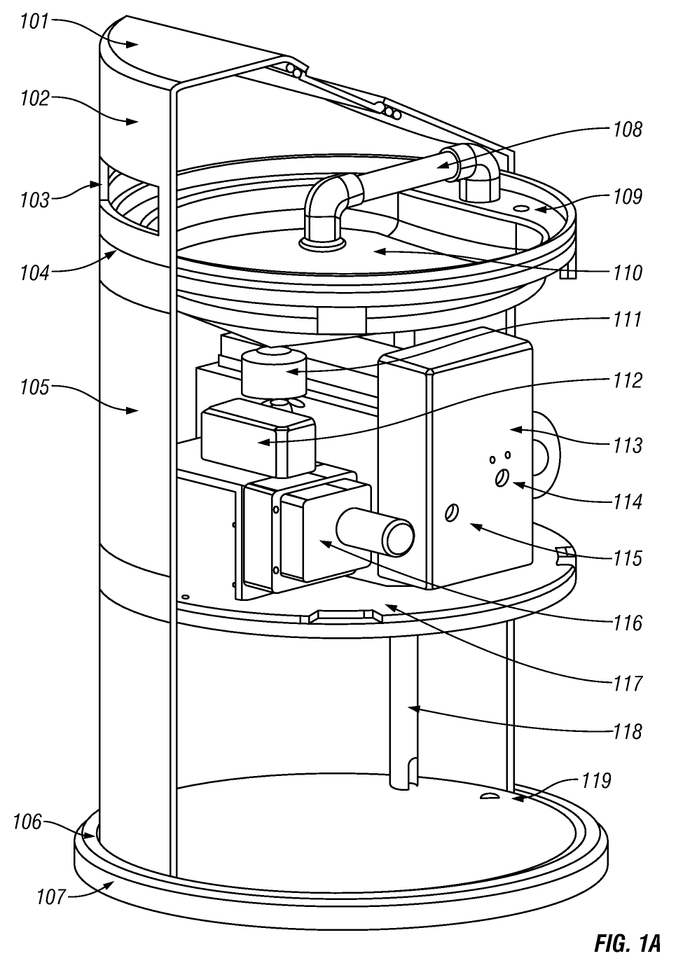

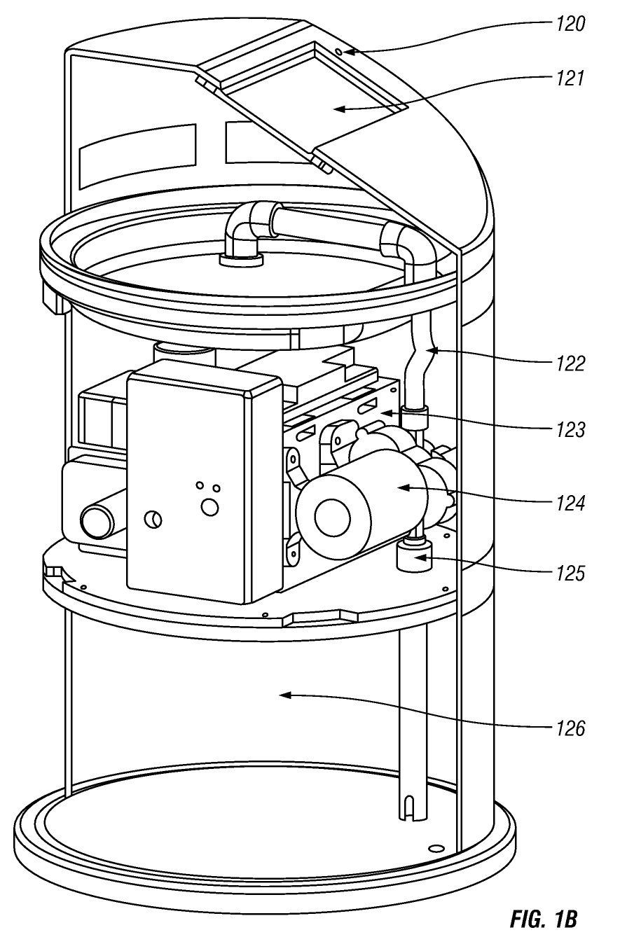

FIGS. 1A and 1B depict a device for eliminating mosquitoes and other flying pests in accordance with a preferred embodiment of the present invention. Specifically, the present invention is a self contained unit with attractants that lure particular types of flying insects such as mosquitoes to enter the unit and lay their eggs in breeding areas filled with water or other liquid provided for this purpose.

FIG. 1A is a right-facing cutaway view of the present invention. The upper portion of the unit includes the breeding area for the insects and is covered with an angled lid (101) that is locked onto the body of the device (105) at ridge 104. The side of the lid (102) includes a screened opening (103) for insects to enter. Inside the breeding area is a fluid filled basin (110) in which the insects lay their eggs. The basin (110) is filled and washed by a liquid spraying system (108). A micro-meshed screened opening (109) allows for airflow through the breeding area.

FIG. 1B is a left-facing cutaway view of the present invention. From this angle, one can more clearly see the solar panel (121) on the lid. In the present example, the lid is slanted but may be shaped differently, e.g., round, domed. Next to the solar panel is a LED indicator and on/off switch (120).

A variety of commonly used attractants can be used with the present invention to lure insects into the breeding area, including light (e.g., UV) and commercially available chemical attractants such as carbon dioxide.

New attractants that have recently been discovered include bacteria that emit gases that attract insects. Specifically, Brevibacterium linens is an effective bacterial strain for attracting insects. Brevibacterium linens is present on human skin and is responsible for causing body odor. This same bacterium is also employed in fermenting several pungent cheeses such as Limburger. Another effective attractant is a plant bi-product from Dracaena, also known as Lucky Bamboo, or a variety of organic compounds.

Repellants can also be used in the areas surrounding the device to drive insects to the device.

In addition to using attractants, the device can be made more attractive to mosquitoes and other insects by heating the device with passive solar heating. A feedbag device can also be employed that provides a mixture of non-coagulant fluid of animal blood or simulated human plasma administered by use of a container that has simulated skin or animal skin that provides the female mosquitoes with a means of obtaining the proteins and chemicals needed to induce egg laying. Similar types of food sources can be used for other types of insects. The use of the attractants and other incentives are all designed to make the device a more appealing breeding ground for insects.

The device is set up by pouring liquid and the attractant into the breeding area basin (110). Insects lured by the attractant and favorable environment of the breeding area lay their eggs in the liquid in the breeding basin (110).

In the bottom of the basin (110) is a drain (not shown) controlled by a valve (111). When turned ON with the on/off switch (120), the valve (111) is opened by a control solenoid (112), allowing liquid held in the breeding area basin (110) to drain through the valve (111) by gravity into the grinding device (116) where insect eggs and larvae are crushed.

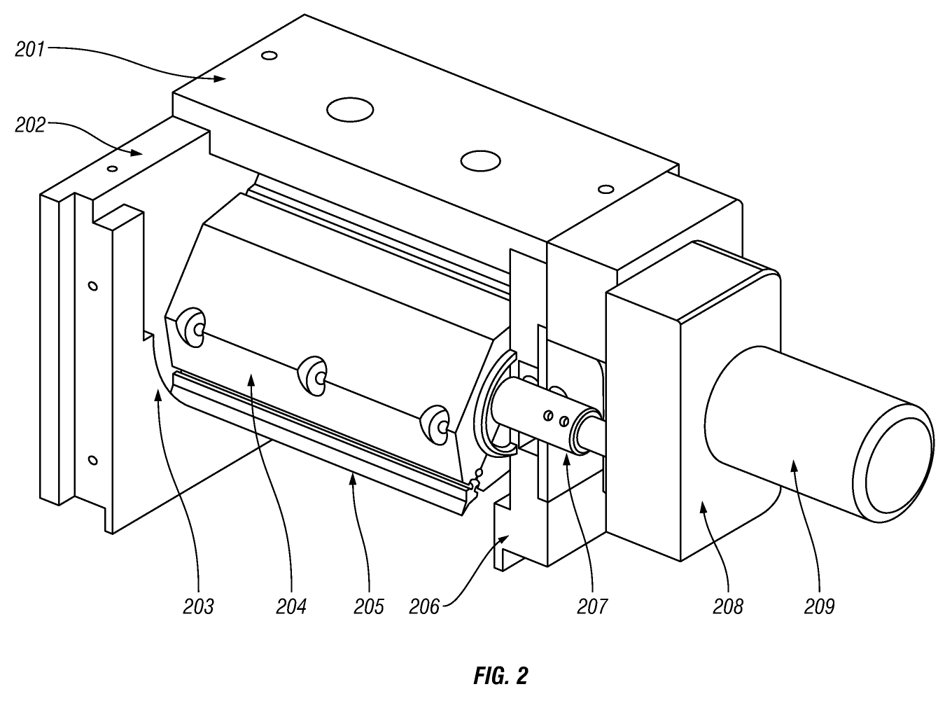

FIG. 2 is a detailed cutaway view of the grinding device in accordance with the present invention. The liquid flows through the valve (111) through openings in the top of the grinding device (201) where the eggs and larvae are separated from the liquid by a mesh located in the grinding device. In this cutaway view, only the mounting edge for the mesh (203) on the end plate (202) is shown. However, it should be understood that the mesh extends along the length of the housing. The mesh is small enough to capture any eggs and larvae in the liquid, while allowing the liquid to pass through.

A rotating oscillator (204) with grinding blades (205) rotates inside the device housing and mechanically crushes the eggs and larvae against the mesh. The rotating oscillator is driven by drive shaft (207) that passes through drive shaft plate (206) and is controlled by a grinding controller (208) fed by electrical connectors (209).

Referring back to FIGS. 1A and 1B, the liquid that flows through the grinding device (116) passes into a reserve area or tank (126) which is separated from the mechanical and electrical components of the invention by a mechanical plate (117).

After the liquid has been drained from the breeding basin (110), the device performs a rinsing cycle by spraying liquid through the spray system (108) to remove any remaining eggs and larvae from the breeding area and further rinses any debris and residue from the grinding mesh (203) into the reserve area (126).

The liquid passes through different types of fibrous filters (not shown) in the reserve area (126) that act as biological filters and destroys the debris. In a preferred embodiment of the invention, these biofilters comprise a variety of course Polyvinyl chloride (PVC) mesh. Once the liquid has passed through the filters, it is clean of any egg and larvae debris. Therefore, the device does not need to be refilled with clean water.

After the rinsing cycle, the solenoid (112) closes the drain valve (111) and the pump (124) activates and pumps the liquid from the reserve area (126) up through the intake pipe (118), bracket (125) and extension (122) into the spraying system (108) which fills the breeding area (110) and returns the device to its waiting period.

The reserve area (126) may be emptied via a drain plug (119) in the base (107). This may be need when relocating the device or changing the biological filters.

The device is a self-contained, compact device that may be AC powered or DC powered. As mentioned above, the top of the device (101) has a built-in solar panel (121) on the slope side which facilitates a trickle charge when the device is operating on DC power. DC power is supplied by a battery (123) which is located in the center of the mechanical platform (117). When the device is plugged into an AC outlet, the DC battery and solar panel are not used. The AC adapter outlet (114) is located on the housing (113) which contains the printed circuit board (not shown).

Regulated operations are set at a select amount of days to recycle. At the appropriate time, the system self-activates and recycles the liquid. The drain and rinse cycle is activated on a cycle that is shorter than the incubation period for hatching the insect eggs, i.e. shorter than the time from when the insect lays the eggs until the eggs hatch. This cycle time will vary depending on the particular species of insect in question. The drain valve (111) can also be activated manually by a release switch (115).

The body of the device (105) is mounted in a channel in the support base (107). In a preferred embodiment, the present invention is approximately 24 to 30 inches tall and approximately 18 inches in diameter, although any size is suitable in height or width. Device shape and product components, as well as the amount of water and attractant, are fully scaleable and subject to change, enabling the device to be manufactured in a variety of sizes according to the needs of the user. Placement of components within the device is also subject to change.

In the preferred embodiments of the present invention, the body of the device is made from plastic. This not only makes the devices lighter and easier to position, it also increases the lifespan of the device in outdoor conditions.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

I claim:

1. A device for eliminating insects, comprising:
(a) a housing;
(b) a basin containing liquid located at the top of said housing;
(c) a lid covering said basin to form a breeding area for insects, wherein the lid includes at least one entrance for insects to enter and lay their eggs in the basin;
(d) a drain valve that drains liquid from the basin, wherein the drain valve is activated on a cycle that is shorter than the incubation period for hatching the insect eggs; and
(e) a grinder in fluid communication with said drain valve, wherein the grinder includes a mesh that captures and separates insect eggs and larvae from the liquid drained from the basin, and wherein the grinder also includes a rotating member that rotates against the surface of said mesh and mechanically crushes any insect eggs and larvae on the mesh.

2. The device according to claim 1, further comprising a liquid reserve area in fluid communication with said grinder that collects drained liquid that passes through the mesh in the grinder.

3. The device according to claim 2, wherein the reserve area includes fibrous filters that remove any biological debris remaining in the drained liquid.

4. The device according to claim 3, wherein the fibrous filters comprise course PVC mesh.

5. The device according to claim 2, further comprising a liquid pump and spray system that pumps liquid from the reserve area and sprays it back into the basin and rinses any remaining eggs and larvae from the breeding area and further rinses any debris and residue from the grinder mesh.

6. The device according to claim 5, wherein the liquid pump and spray system refills the basin when the drain valve closes.

7. The device according to claim 1, wherein the breeding area contains at least one insect attractant.

8. The device according to claim 7, wherein the attractant is in the liquid.

9. The device according to claim 7, wherein the attractant is bacteria that emit gases that attract insects.

10. The device according to claim 9, wherein the bacteria is Brevibacterium linens.

11. The device according to claim 1, wherein the device is solar powered.

12. The device according to claim 11, wherein the lid contains a solar panel.

13. The device according to claim 12, wherein the solar panel charges a battery contained in the device.
